(19) United States
(12) Patent Application Publication
(10) Pub. No.: US 2007/0183747 A1
(43) Pub. Date: Aug. 9, 2007

(54) Digital signal recording and playback apparatus

(75) Inventors: Akinobu Watanabe, Yokohama (JP); Kenji Katsumata, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/646,801

(22) Filed: Dec. 27, 2006

(30) Foreign Application Priority Data
Feb. 3, 2006 (JP) 2006-026496

(51) Int. Cl. H04N 5/91

(52) U.S. Cl. 386/94

(57) ABSTRACT

An object of the present invention is to provide a digital signal recording and playback apparatus for, even in the case of a program whose recording is not permitted (for example, Never Copy), performing, on the digital signal receiving side, recording and playback control that is limited to time shifting. In order to achieve the above object, there is provided a digital signal recording and playback apparatus that writes digital signals to different recording areas on the recording medium, the recording areas including a first recording area to which an ordinary digital signal is written, and a second recording area to which an encrypted digital signal having a copy restriction control flag is written, the digital signal recording and playback apparatus erasing, under specified conditions, an encryption key of the digital signal written to the second recording area.

### CLAIM OF PRIORITY

The present application claims priority from Japanese application serial No. JP 2006-26496, filed on Feb. 3, 2006, the content of which is hereby incorporated by reference into this application.

### BACKGROUND OF THE INVENTION

(1) Field of the Invention

The present invention relates to a digital signal recording and playback apparatus for receiving digital broadcasts, and for writing/reading received video and audio signals to/from a recording medium with copy control being performed.

(2) Description of the Related Art

In recent years, with the development of digital storage media, techniques for compressing a long-time video data with audio data so as to write the video data to the storage media have been studied. As a result, it becomes possible to record a long-time video data such as a movie to one medium with the high image quality being kept unchanged. As recording media, HDDs (hard disk drives) are generally used as the main storage of personal computers, or the like. The capacity of the HDDs is increasing, and the prices of the HDDs are being reduced. Recorders with built-in HDD, which are used for AV (Audio Visual) content, are achieving widespread use.

Incidentally, Japanese Patent Application Laid-Open No. 2002-244926 (Patent Document 1) describes time shift playback of Copy Never content. To be more specific, as disclosed in Patent Document 1, in order to provide a data disabling apparatus that is capable of improving the convenience of users without deviating from the point that copying of data is not permitted (according to objects described in Abstract), the data disabling apparatus comprises: a receiving unit 102 for receiving data indicating that copy is disallowed; a recording unit 107 for dividing the received data into pieces of partial data to record the data; a playback unit 110 for successively playing back the recorded partial data; a disabling judgment unit 111 for judging that the partial data should be disabled as a result of the expiration of the recording time limit, the playback of the partial data, or the like; a successive disabling unit 113 for, in order to utilize at least other data among the pieces of partial data to be disabled, successively destructing required data by overwriting the required data with new data or arbitrary data (according to means for achieving the objects described in Abstract).

### SUMMARY OF THE INVENTION

“iVDR (Information Versatile Disk for Removable usage)” is being developed. The impact resistance that is one of the weak points of HDDs, and the data security that is becoming a problem in recent years, are improved in the iVDR.

The iVDR has the following characteristics:

1. the iVDR is a removable hard disk drive that is small, light, and portable;

2. although the iVDR is a removable hard disk drive, the iVDR is capable of large-capacity recording and high-speed random access, which are advantages of hard disk drives;

3. an interface (signal unit) conforms to Serial ATA, and is capable of high-speed data transmission whose transmission rate is 1.5 Gbps;

4. if a plurality of iVDRs are used, users can easily build even a server having a capacity of TB (Tera Bytes);

5. because secure standards based on PKI (Public Key Infrastructure) are developed, the protection of recorded data information and the protection of copyrighted digital content are achieved.

In particular, taking advantages of the fifth characteristic, also for the copyright management that is expected to be severer in future, the diffusion of the iVDR is expected as a recording medium that includes in itself a function of coping with the copyright management.

In general, there are four kinds of conventional copy control information as follows: “Never Copy” that permits no copying; “Copy Once” that permits copying only once; “Copy Free” that permits copying any number of times; and “No More Copy” that is a child copy of the Copy Once. For example, a digital signal received from a broadcasting station includes information such as Never Copy, Copy Once, and Copy Free. When a user makes a backup to a recording medium of the user, the above-described copy information restricts the operation of the user as follows: in the case of Never Copy, the user cannot make a copy because copying is not permitted; in the case of Copy Once, the user can perform recording as time shifting which means that the time to watch is shifted, and accordingly the user can make a child copy to a recording medium only once (in this case, the digital signal which has been written to the recording medium becomes No More Copy, and accordingly a child copy cannot be further created from the child copy in question); and in the case of Copy Free, the user can make a copy any number of times.

If the user wants to watch an on-air program at the arbitrary time, or if the user wants to watch the program not only once but also several times, there is a request that the user is allowed to temporarily record the program in a recording apparatus of the user for the purpose of time shifting. However, if broadcasting which is subjected to copy control is performed on broadcasting or cable broadcasting services, it is not possible to perform recording for the purpose of time shifting. Moreover, in the case of digital recording achieved by digital broadcasting or cable broadcasting, which will become a mainstream in future, it is possible to perform recording with the high image quality being kept unchanged. Therefore, it is expected that a ratio of the method which does not allow recording like Never Copy will increase, and consequently the restriction on digital recording will become severer than that on analog recording.

Thus, Never Copy which is expected to be frequently used in digital broadcasting does not satisfy the request of users for time shift recording. Because the time at which a user watches a program cannot be freely changed by the user, the user is obliged to limit action or to give up watching. As a result, only part of users can enjoy the benefits of digital broadcasting.

In addition, as far as the invention described in Patent Document 1 is concerned, it is necessary to add a temporary copy permission flag to an inputted digital signal. For this purpose, it is necessary to change a format of the broadcast signal. This forces a large change to both digital broadcasting transmission systems and digital broadcasting receiving systems, which is a problem to be solved.

An object of the present invention is provide a digital signal recording and playback apparatus whose usability is improved in a state in which the digital signal recording and playback apparatus records both a digital signal with no restriction on recording and playback thereof and a digital signal that can be played back only under a specified condition.

The above problem can be solved by the inventions described in claims.

### BRIEF DESCRIPTION OF THE DRAWINGS

These and other features, objects and advantages of the present invention will become more apparent from the following description when taken in conjunction with the accompanying drawings wherein:

FIG. 1 is a diagram illustrating a configuration of a recording and playback apparatus according to a first embodiment of the present invention;

FIG. 2 is a schematic diagram illustrating the data structure of a recording medium according to the first embodiment of the present invention;

FIG. 3 is a schematic diagram illustrating the data structure of a first area of the recording medium according to the first embodiment of the present invention;

FIG. 4 is a schematic diagram illustrating the data structure of a second area of the recording medium according to the first embodiment of the present invention;

FIG. 5 is a schematic diagram illustrating the logical data structure of the first area of the recording medium according to the first embodiment of the present invention;

FIG. 6 is a schematic diagram illustrating the logical data structure of the second area of the recording medium according to the first embodiment of the present invention;

FIG. 7 is a flowchart illustrating the process flow of storing an encryption key according to a second embodiment of the present invention;

FIG. 8 is a flowchart illustrating the process flow of acquiring an encryption key according to the second embodiment of the present invention;

FIG. 9 is a flowchart illustrating the process flow of erasing an encryption key according to the second embodiment of the present invention;

FIG. 10 is a flowchart illustrating the process flow of erasing an encryption key according to the second embodiment of the present invention; and

FIG. 11 is a diagram illustrating an access pattern according to the second embodiment of the present invention.

### DETAILED DESCRIPTION OF THE PREFERRED EMBODIMENTS

Taking as an example an image information encode decode recording and playback apparatus, which records/plays back video and audio signals as a recording and playback apparatus, one embodiment of the present invention will be described with reference to drawings as below.

### First Embodiment

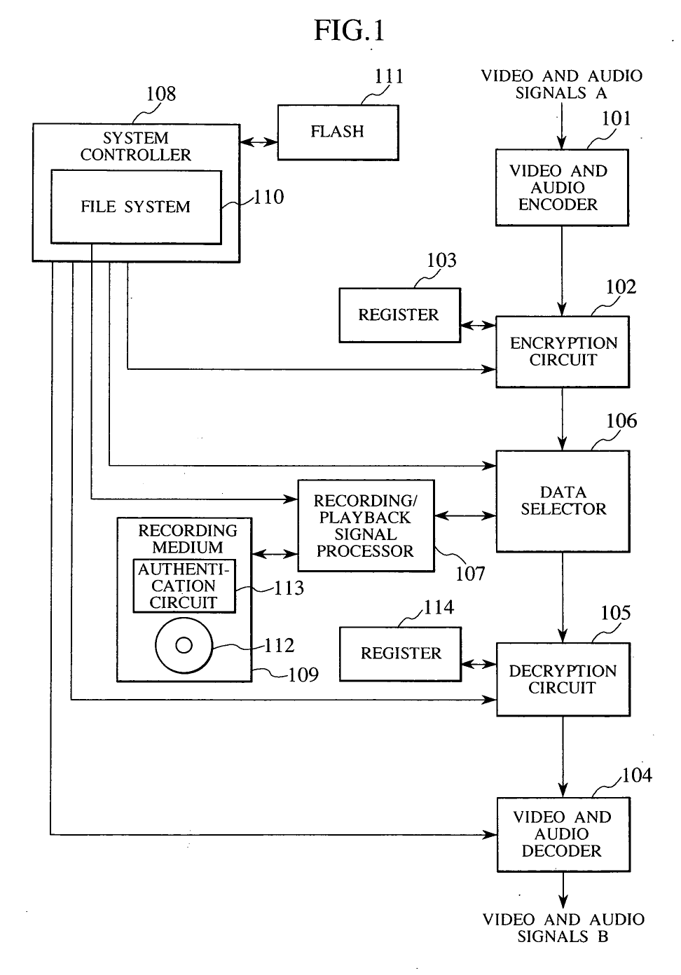

FIG. 1 is a diagram illustrating a configuration of a recording and playback apparatus according to a first embodiment of the present invention. The recording and playback apparatus includes a video and audio encoder 101, an encryption circuit 102, a register 103, a video and audio decoder 104, a decryption circuit 105, a data selector 106, a recording/playback signal processor 107, a system controller 108, a recording medium 109, a FLASH memory 111, and a register 114.

The system controller 108 includes a file system 110. The recording medium 109 includes an authentication circuit 113 and a data storage area 112.

For example, when analog video and audio signals A are inputted, the video and audio encoder 101 encodes the signals A into a MPEG format, and subsequently the encryption circuit 102 performs local encryption processing. At this time, the system controller 108 sets an encryption key for the encryption circuit 102, and the encryption circuit 102 performs local encryption processing by use of the set encryption key. During the local encryption processing, the encryption key is stored in the register 103. The encrypted signal is recorded to the recording medium 109 by the recording/playback signal processor 107 through the data selector 106.

The recording medium 109 includes the authentication circuit 113 and the data storage area 112. Authentication is performed between the system controller 108 and the authentication circuit 113 if necessary. If the authentication has been successfully completed with no problem, the encrypted signals A are recorded to the data storage area 112. After the completion of the recording, the encryption key stored in the register 103 is erased. In addition, also if the power supplied to the apparatus is stopped, the encryption key stored in the register 103 is erased. Incidentally, the recording medium 109 is a removable recording medium that can be removed from the apparatus (for example, a portable hard disk).

When data is played back from the recording medium 109, the data played back from the recording medium 109 by the recording/playback signal processor 107 is sent to the decryption circuit 105 through the data selector 106. Next, the decryption circuit 105 decrypts the locally encrypted data, and then the video and audio decoder 104 performs MPEG decode processing of the decrypted data. The data is output as video and audio signals B. The decryption circuit 105 performs decryption processing while the decryption key set by the system controller 108 is stored in the register 114. After the completion of the playback, the decryption key stored in the register 114 is erased. In addition, also if the power supplied to the apparatus is stopped, the decryption key stored in the register 114 is erased.

Incidentally, there is also a case where instead of the analog video and audio signals A, the MPEG stream having been subjected to MPEG encode processing is inputted. However, in such a case, there is only one point of difference that the MPEG stream is inputted into the encryption circuit 102 by bypassing the video and audio encoder 101.

In addition, if encryption is not required, it is also possible to transmit the MPEG stream to the data selector by bypassing the encryption circuit 102. Moreover, if decryption is not required, it is also possible to transmit the stream from the data selector by bypassing the decryption circuit 105. The local encryption processing is such encryption processing that encrypted data can be decrypted only by an apparatus which is used to encrypt the data. The local encryption processing can be achieved by the following method. For example, a seed of an encryption key is created on a basis of a value into which information specific to the apparatus (for example, a serial number of the apparatus), a serial number of an encryption LSI, and the like, are combined. In addition to it, the encryption key is not written to a recording media such as a HDD.

Incidentally, the number of encryption keys is not limited to one for each recording medium. For example, each recorded content may also be provided with a different encryption key.

In addition, it is not always necessary to store these encryption keys in one memory. Several kinds of memories can also be properly used according to how to use the encryption keys. For example, an encryption key used for time shifting is stored in a volatile memory, whereas the other encryption keys are stored in a FLASH memory.

The system controller 108 switches operation between recording and playback. If recording and playback are concurrently performed, the system controller 108 controls the operation by means of time sharing so that switching is performed between playback of data from the optical disk 109 and recording of data to the optical disk 109 according to which operation is to be performed, that is to say, playback operation or recording operation. In addition, the data selector 110 is so controlled that during the recording operation, data flows from the encryption circuit 102 to the recording/playback signal processor 107, whereas during the playback operation, data flows from the recording/playback signal processor 107 to the decryption circuit 105.

Moreover, the system controller 108 switches between operation with encryption or decryption and operation without encryption or decryption. If data is not encrypted, the encryption circuit 102 is brought into a state in which the local encryption processing does not function. Then, the signal which is inputted from the video and audio encoder 101 to the encryption circuit 102 is directly output to the data selector 106. If data is not decrypted, the decryption circuit 105 is brought into a state in which the decryption processing does not function. Then, the signal which is inputted from the data selector 106 to the decryption circuit 105 is directly output to the video and audio decoder 104.

The system controller 108 performs authentication with the authentication circuit 113 of the recording medium 109. If the authentication is successfully completed, it becomes possible to access the data storage area 112. On the other hand, if the system controller 108 fails the authentication, the data storage area 112 cannot be accessed.

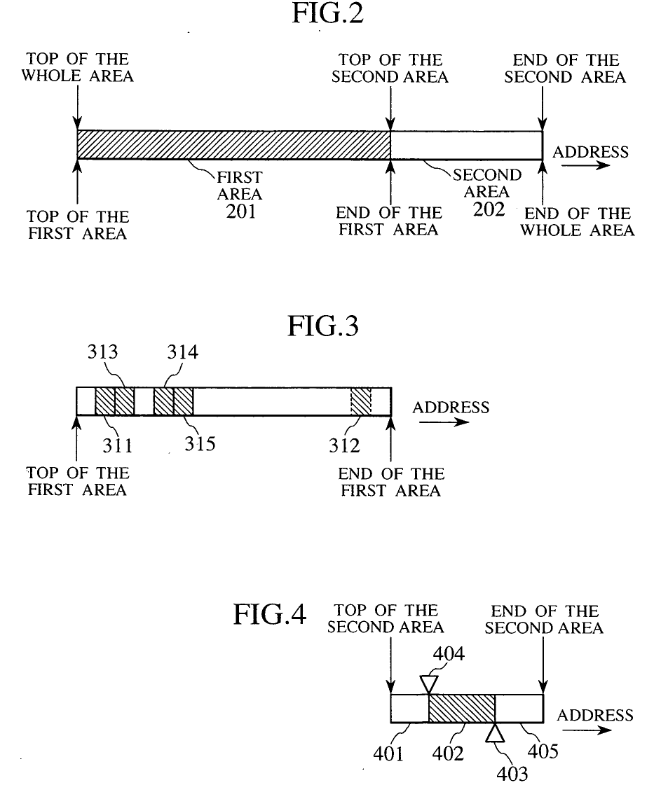

Next, the data structure of the recording medium shown in FIG. 2 will be described. FIG. 2 is a schematic diagram illustrating the data structure of the recording medium. FIG. 2 illustrates two kinds of areas. Addresses of the recording medium are assigned in the left-to-right direction of the figure. The left end of the figure corresponds to the top of the whole area, whereas the right end of the figure corresponds to the end of the whole area.

The data structure includes a first area 201 and a second area 202. The top of the first area coincides with the top of the whole area. The end of the second area coincides with the end of the whole area. A normal access is made to the first area; and time shift playback of Copy Never content is performed from the second area.

Next, the data structure of the recording medium shown in FIG. 3 will be described. FIG. 3 is a schematic diagram illustrating the data structure of the first area of the recording medium. FIG. 3 illustrates a state in which data is recorded in the UDF (Universal Disk Format) structure. Addresses of the recording medium are assigned in the left-to-right direction of the figure. The left end of the figure corresponds to the top of the first area, whereas the right end of the figure corresponds to the end of the first area.

The data structure includes a first AVDP (Anchor Volume Descriptor Pointer) 311, a second AVDP (Anchor Volume Descriptor Pointer) 312, a VDS (Volume Descriptor Sequence) 313, a FSD (File Set Descriptor) 314, and SBD (Space Bitmap Descriptor) 315.

The first AVDP 311 is written at a fixed address, and has information indicating a starting point of a disk access. The first AVDP 311 is an address at which the VDS 313 is written. If reading of the first AVDP 311 fails, the second AVDP 312 is referred to. The second AVDP 312 is a copy of the first AVDP 311. The second AVDP 312 is written at a fixed address in proximity to the end of the first area. This fixed address is spaced away from the address at which the first AVDP 311 is written.

The VDS 313 includes information about the first area such as an address of the SBD 315, and an address of the FSD 314. The FSD 314 includes a position of a root directory. As described above, it becomes possible to make an access to a file on the basis of the AVDP 311.

FIG. 5 is a diagram schematically illustrating the abovementioned state. Because similar reference numerals are used in FIG. 5 to denote parts that are similar to those shown in FIG. 3, the description thereof will be omitted. The file structure includes a root directory entry 501 and a root directory 502. The FSD 314 points to a file area. The root directory entry 501 exists at the top of the file area. The root directory entry 501 has an address of the root directory 502.

Incidentally, if recording is made to the first area, the local encryption processing is not performed by the encryption circuit 102. In addition, if playback is made from the first area, the local decryption processing is not performed by the decryption circuit 105.

Next, the data structure of the recording medium shown in FIG. 4 will be described. FIG. 4 is a schematic diagram illustrating the data structure of the second area of the recording medium. FIG. 4 illustrates a state in which data is recorded in a specific format structure. Addresses of the recording medium are assigned in the left-to-right direction of the figure. The left end of the figure corresponds to the top of the second area, whereas the right end of the figure corresponds to the end of the second area. The data structure includes a read area 401, a written area 402, an unwritten area 405, a write pointer 403, and a read pointer 404.

The whole area is structured as a ring. When data is written to this area, the recording is first started from the top of the second area. Then, the data is successively recorded up to the end of the second area. After the recording reaches the end of the second area, if the next recording is made, the recording is continued after returning to the top of the second area. Thereafter, the same recording operation is repeated until the recording stops. The write pointer 403 shown in the figure indicates a position at which the recording is made.

In the case of playback of data, after recording starts, playback is started from the top of the second area. Then, the data is successively played back up to the end of the second area. After the playback reaches the end of the second area, if the next playback is made, the playback is continued after returning to the top of the second area. Thereafter, the same write operation is repeated until the playback stops. The read pointer 404 shown in the figure indicates a position at which the playback is made.

Playback and recording are controlled so that the read pointer 404 does not overtake the write pointer 403, and so that the write pointer 403 does not overtake the read pointer 404. If the read pointer 404 overtakes the write pointer 403, or if the write pointer 403 overtakes the read pointer 404, the playback is stopped.

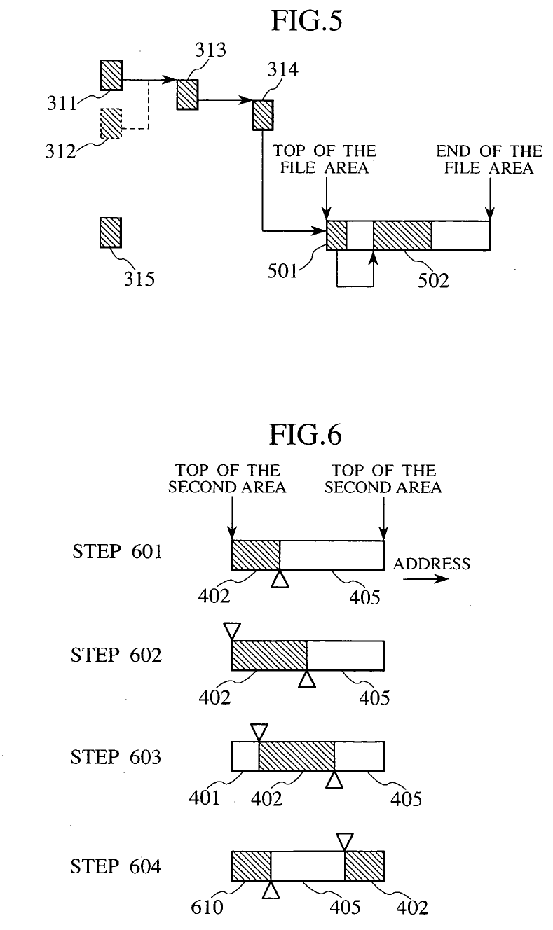

FIG. 6 is a schematic diagram illustrating the data structure of the second area at the time of the time shift playback. Starting from a step 601, the process proceeds in the order of a step 602, a step 603, and a step 604. The step 601 shows a state in which data is recorded to an area 402 ranging from the top of the second area to the write pointer 403. To be more specific, the area 402 is a recorded area from which written data has not yet been played back. The area 405 is an unrecorded area.

In the step 602, the recording progresses in comparison with the step 601. In other words, the write pointer 403 gets closer to the end of the second area. In addition, the read pointer 404 is located at the top of the second area, and the time shift playback is about to be started.

In the step 603, the recording further progresses in comparison with the step 602, and the time shift playback also progresses. Both the write pointer 403 and the read pointer 404 get closer to the end of the second area. The area 401 is an area from which the written data has been read out to play back the written data. Therefore, even if the area 401 is overwritten, no problem arises.

In the step 604, both the recording and the playback further progress in comparison with the step 603. The step 604 shows a state in which after the write pointer 403 reaches the end of the second area, overwriting is performed from the top of the second area. In this state, the area 402 and the area 610 are recorded areas from which the written data has not yet been played back. On the other hand, the area 401 is an area from which the recorded data has been read out for playback. Therefore, even if the area 401 is overwritten, no problem arises. As described above, the time shift playback is achieved by controlling recording and playback.

When Copy Never content is recorded to the second area, the local encryption processing is performed. When the time shift playback of the recorded Copy Never content is performed, decryption processing is performed by use of the encryption key that is used for the local encryption processing. The encryption key used for the local encryption processing is stored only in a volatile memory (the register 103 and the register 114). Accordingly, stopping of the power causes the encryption key to be erased. As a result, even if the data which is written to the second area on the recording medium is read out, it is not possible to decrypt the data for playback. This produces substantially the same effects as those of a state in which no data is written to the recording medium.

Incidentally, although the number of encryption keys is one in this embodiment, a plurality of encryption keys may also be used. If an encryption key is changed to another key at intervals of a fixed period of time, the higher security can be achieved, which is a produced effect of the present invention.

The recording medium 109 is a removable medium that can be removed from the apparatus. Additionally, as illustrated in FIG. 1, the authentication circuit 113 is built into the recording medium 109.

When the recording medium 109 is mounted to the apparatus, or when the power is supplied to the apparatus with the recording medium 109 being mounted to the apparatus, the system controller 108 performs authentication with the authentication circuit 113 of the recording medium 109 to judge whether or not the recording medium 109 can be accessed. Consequently, if the authentication is successfully completed with the result that the recording medium 109 is judged to be accessible, it is possible to access the first and second areas.

If the authentication fails with the result that the recording medium 109 is judged to be inaccessible, an access to each of the first area and the second area is disallowed. To be more specific, no apparatus other than the apparatuses which conform to the authorized standards can access the second area.

When the time shift playback of the Copy Never content is performed, the first area is not accessed. However, recording to the second area is made. Because of time shifting, the Copy Never content written to the second area is subjected to the local encryption. In addition to it, because the encryption key is stored only in the register 103 and the register 114 included in the apparatus, the recording medium 109 has no encryption key.

Here, it is assumed that after the time shift operation is completed, the recording medium 109 is mounted to another apparatus. Even if the content of the second area can be read out, it is not possible to play back the content because there is no encryption key (decryption key). In other words, there is produced an effect of preventing the Copy Never content from being illegally copied. In addition, in the case of usual apparatuses for which the time shift playback of Copy Never content is not taken into consideration, because only an access to the first area is made, processing similar to the conventional processing can be performed. This is also a produced effect of the present invention.

As described above, the recording and playback apparatus according to this embodiment can achieve the time shift playback of Copy Never content by performing the steps of: encrypting a digital signal; recording the signal to an area which differs from a normal recording area; and erasing an encryption key used for the encryption after recording is completed. Moreover, there is also an effect of achieving the time shift playback of Copy Never content without sacrificing the copy control mechanism used for the conventional digital broadcasting and the functions of removable media that are provided with an authentication function.

### Second Embodiment

A configuration of a recording and playback apparatus according to a second embodiment of the present invention will be described with reference to FIG. 1. A point of difference between the first and second embodiments is that an encryption key is stored in the FLASH memory 111. However, if the encryption key is kept to be stored in the FLASH memory 111 without limitation, the Copy Never content can be played back. Therefore, a period of time during which the encryption key is stored in the FLASH memory 111 is limited.

As a method for limiting the period of time, for example, two ways of methods can be considered as follows.

First of all, when recording to the second area of the recording medium 109 is started, an encryption key is stored in the FLASH memory 111. When the recording to the second area ends, the stored encryption key is erased. This makes it possible to play back the content recorded to the second area only during the recording to the second area. Accordingly, only the time shift playback becomes possible, which is an effect of this method.

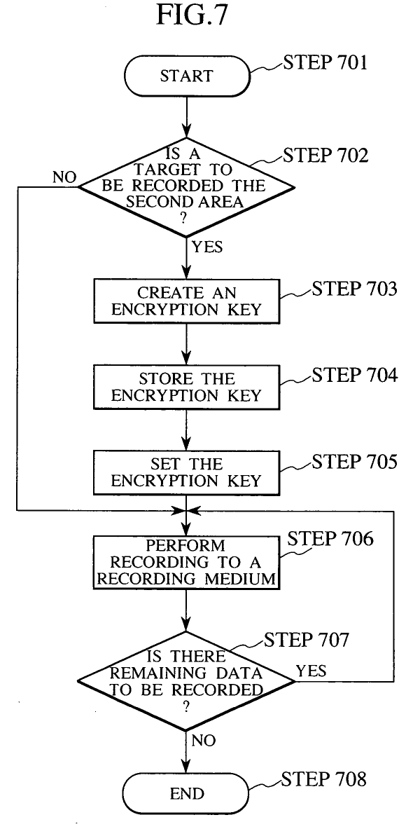

FIG. 7 is a flowchart illustrating the process flow of storing an encryption key according to the second embodiment. Upon the reception of a request to record data to the recording medium 109 (step S701), a judgment is made as to whether or not a target to be recorded is the second area (step S702). If the target to be recorded is not the second area, data is recorded to the recording medium 109 (step S706). If the target to be recorded is the second area, an encryption key is created (step S703). The created encryption key is then stored in the FLASH memory 111 (step 704). After that, the encryption key is set in the encryption circuit 102 (step S705), and recording to the recording medium 109 is made (step 706). Thereafter, if the amount of remaining data to be recorded is larger than 0, recording to the recording medium 109 is continuously performed (step S707). The recording processing is repeated until the amount of remaining data becomes 0. At a point of time at which recording of all data is completed, the recording processing ends (step 708).

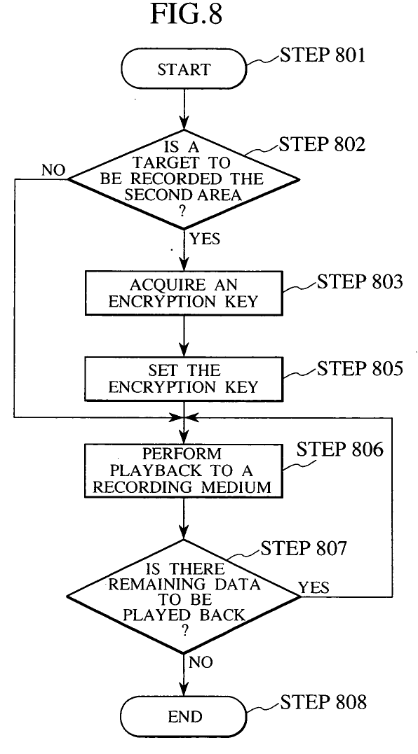

Incidentally, as shown in the process flow of acquiring an encryption key in FIG. 8, playback processing includes the steps as described below.

Upon the reception of a request to record data to the recording medium 109 (step S801), a judgment is made as to whether or not a target to be recorded is the second area (step S802). If the target to be recorded is not the second area, playback is performed from the recording medium 109 (step S806). If the target to be recorded is the second area, an encryption key is acquired from the FLASH memory 111 (step S803). The acquired encryption key is then set in the decryption circuit 105 as a decryption key (step S805), and playback is performed from the recording medium 109 (step 806). Thereafter, if the amount of remaining data to be played back is larger than 0, the playback is continuously performed from the recording medium 109 (step S807). The playback processing is repeated until the amount of remaining data becomes 0. At a point of time at which playback of all data is completed, the playback processing ends (step 808).

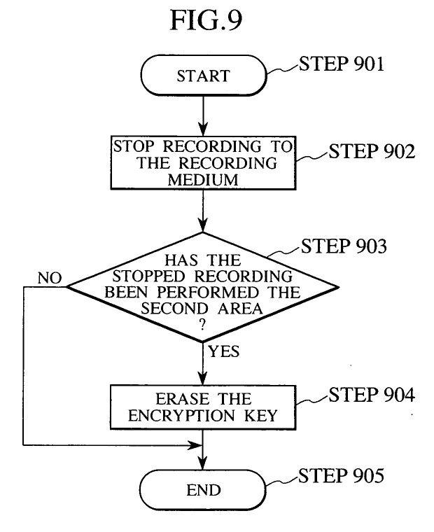

Next, FIG. 9 is a flowchart illustrating the process flow of erasing an encryption key according to the second embodiment. After the completion of recording to the recording medium 109, if a request to perform recording stop processing is received (step S901), the recording to the recording medium 109 is stopped, and then the recording stop processing including writing of management information is executed (step 902). After that, a judgment is made as to whether or not the stopped recording has been performed to the second area (step 903). If the stopped recording has not been performed to the second area, the process ends (step 905). If the stopped recording has been performed to the second area, the encryption key stored in the FLASH memory 111 is erased (step 904), and then the process ends (step 905).

Secondly, at the time of starting the recording to the second area, an encryption key is stored in the FLASH memory 111. When the second area is first accessed after the recording to the second area ends, the encryption key is erased. As a result, even if the power supply is interrupted during the recording to the second area, the playback processing cannot be carried out in a state in which the encryption key and the encrypted Copy Never content coexist in the apparatus. This produces substantially the same effects as a state in which no data is recorded to the recording medium.

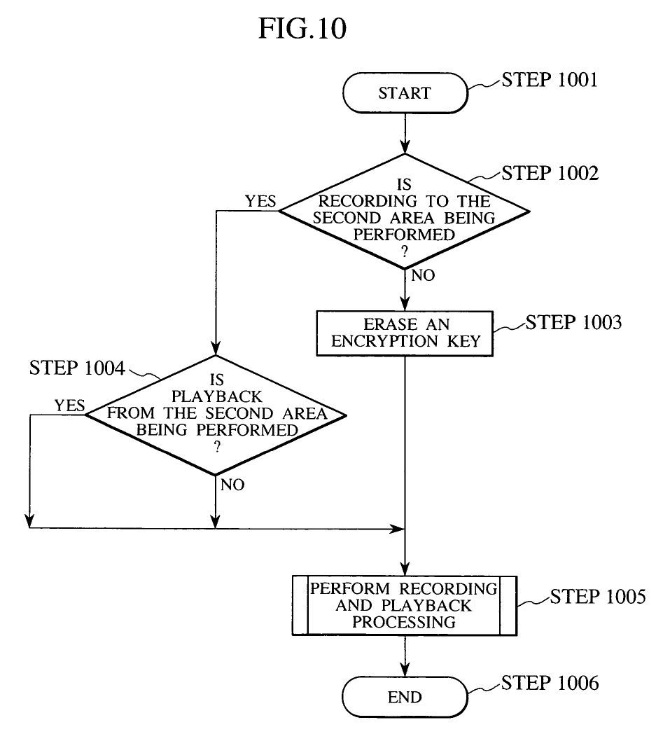

FIG. 10 is a flowchart illustrating as an example the process flow of erasing an encryption key according to the second embodiment. Upon the reception of a request to record to or play back from the recording medium 109 (step 1001), a judgment is made as to whether or not recording to the second area is currently being made (step 1001). If recording to the second area is not currently being made, the encryption key is erased from the FLASH memory 111 (step 1003). If recording to the second area is currently being made, a judgment is made as to whether or not the playback from the second area is currently being made (step 1004). If the playback from the second area is not currently being made, recording and playback processing is performed (step 1005). Also, if the playback from the second area is currently being made, the recording and playback processing is performed (step 1005).

Incidentally, the recording and playback processing (step 1005) is the same as the recording processing or the playback processing described above. Therefore, detailed description thereof will be omitted. In addition, because the process flow of storing the encryption key is the same as that of the storing processing of the first limiting method, the description thereof will be omitted.

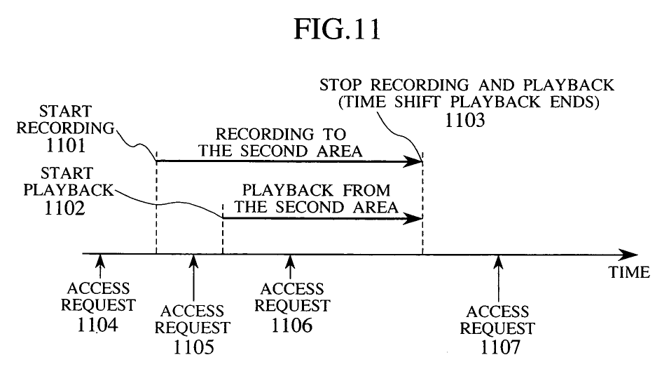

How processing is performed on a pattern basis will be described with reference to FIG. 11. First of all, recording to the second area is started (1101). Next, playback from the second area is started (1102). Then, in the timing in which time shift playback ends, recording to and playback from the second area are stopped (1103).

In this case, four kinds of access patterns can be considered as follows.

A first access pattern is an access request 1104 to access the second area. The access request 1104 is received before the recording to the second area is started (1101). In this case, it is judged in the step 1002 that recording to the second area is not currently being made. Accordingly, the encryption key is erased in the step 1003. As a result, it is not possible to decrypt data read out from the second area, and accordingly playback cannot be carried out.

A second access pattern is an access request 1105 to access the second area. The access request 1105 is received after the recording to the second area is started (1101), and before the playback from the second area is started (1102). In this case, it is judged in the step 1002 that recording to the second area is currently being performed, and it is also judged in the step 1004 that playback from the second area is not currently being performed. Therefore, it is possible to perform the time shift playback from the second area.

A third access pattern is an access request 1106 to access the second area. The access request 1106 is received after the playback from the second area is started (1102), and before the time shift playback ends (1103). In this case, it is judged in the step 1002 that recording to the second area is currently being performed, and it is also judged in the step 1004 that playback from the second area is currently being performed. Therefore, it is possible to perform the time shift playback from the second area.

A fourth access pattern is an access request 1107 to access the second area. The access request 1107 is received after the time shift playback ends (1103). In this case, it is judged in the step 1002 that recording to the second area is not currently being performed. As a result, the encryption key is erased in the step 1003. Therefore, it is not possible to decrypt the data read out from the second area, and accordingly the data cannot be played back.

As described above, so long as recording to the second area is not being performed, it is not possible to decrypt the data read out from the second area so as to play back the data. Accordingly, for example, even if the power supply is interrupted during the time shift playback, the encryption key is erased at the time of the first access after the apparatus is restarted. Therefore, there is no possibility that the Copy Never content will be played back for purposes other than the time shift playback.

In the above embodiments, the first area is constituted of one partition that conforms to the UDF standards, whereas the second area is formed in a specific format. However, the first and second areas may also be configured in other ways.

For example, the whole recording medium may also be configured to have the volume structure that conforms to certain UDF standards, and to have two partitions (partitions 1, 2). In this configuration, the partition 1 functions as the first area, and the partition 2 functions as the second area.

In this case, an access to the partition 1 can be made in the same manner as that of this embodiment, and the partition 2 is subjected to the local encryption processing. Accordingly, even if the partition 2 is accessed, it is not possible to play back the read data.

In addition, the file system is not limited to the UDF standards. FAT, NTFS, or the like, can also be adopted without causing any problem.

In this embodiment, signals are written to different areas. More specifically, an ordinary digital signal is written to the first area, whereas an encrypted digital signal is written to the second area. Accordingly, the second area to which the encrypted digital signal is temporarily written does not influence the first area to which the other digital signals are written; or in contrast with this, the second area to which the encrypted digital signal is temporarily written is not influenced by the first area to which the other digital signals are written, which is one of the effects of the present invention.

To be more specific, a management method (for example, a file system) for managing the second area can be configured independently of a management method for managing the first area. Therefore, the processing of handling the second area can be implemented in any manner (for example, simply or with high functionality) without being influenced by the management method for managing the first area. Such flexibility is one of the effects of the present invention. In addition, because the second area can be concealed from a system for managing the first area, little influence is exerted on the system for managing the first area, which is also one of the effects of the present invention.

Moreover, if the first and second areas are partitions, it is possible to independently manage the amount of written space, and the amount of free space, of the first and second areas. Accordingly, it is possible to easily manage the remaining recordable time. This is also one of the effects of the present invention. Further, because all-data erasure processing (initialization processing) can be carried out on a partition basis, management is easy, which is also one of the effects of the present invention.

In addition, if an encryption key of a digital signal written to the second area is erased after the recording ends, even if the time shift playback of Copy Never content is performed, it is possible to reliably disallow an access to the Copy Never content after the time shift processing ends. This is also one of the effects of the present invention. Moreover, even if the power supply is interrupted while an encrypted digital signal is being written, an encryption key can be reliably erased. Accordingly, it is possible to prevent Copy Never content from being kept in a state in which users can access the Copy Never content. This is also one of the effects of the present invention.

Further, on the assumption that an encryption key for an encrypted digital signal written to the recording medium is stored in the nonvolatile memory module before recording is started, if the encryption key is erased from the nonvolatile memory module when the recording ends, or at the time of the first access after the recording ends, even if the time shift playback of Copy Never content is performed, it is possible to disallow an access to the Copy Never content after the time shift processing ends, which is also one of the effects of the present invention. Moreover, even if the power supply is interrupted while an encrypted digital signal is being written, an encryption key can be reliably erased. Accordingly, it is possible to prevent Copy Never content from being kept in a state in which users can access the Copy Never content. This is also one of the effects of the present invention.

In addition, if a recording medium is a removable medium, it is possible to easily replace the recording medium in the case of a failure of the recording medium, which is also one of the effects of the present invention. In addition, even if the storage capacity of the recording medium becomes insufficient, the storage capacity can be increased by replacing the recording medium with a recording medium with larger storage capacity. This makes it possible to extend the recording time, which is also one of the effects of the present invention.

Furthermore, if it is controlled so that Copy Never content becomes accessible only when the authentication is successfully completed between the authentication module and the detection control module, even if recording to or playback from a removed recording medium is attempted using another apparatus, the Copy Never content cannot be accessed because the authentication fails. Therefore, it is possible to prevent the Copy Never content from being illegally spread out. This is also one of the effects of the present invention.

The above-described embodiments are based on the assumption that the embodiments are applied to the time shift playback of a digital signal providing an indication that copying is allowed or disallowed. However, the present invention is not limited to this assumption. For example, if a length of time of recording to the recording medium 109 or that of playback from the recording medium 109 is limited to a specified period of time as one of digital-signal copy control or digital-signal playback control, it is possible to apply the above embodiments to this case. Thus, if an encrypted digital signal to which specified copy control or playback control is added is written to the second area, erasing the encryption key under a specified condition makes it possible to provide a method for reducing a load of a digital recording and playback apparatus while user requests and requests on the content delivery side are kept balanced.

As described above, according to the present invention, it is possible to provide a digital signal recording and playback apparatus whose usability is improved.

While we have shown and described several embodiments in accordance with our invention, it should be understood that disclosed embodiments are susceptible to changes and modifications without departing from the scope of the invention. Therefore, we do not intend to bound by the details shown and described herein but intend to cover all such changes and modifications as fall within the ambit of the appended claims.

What is claimed is:

1. A digital signal recording and playback apparatus for recording an inputted digital signal to a recording medium, and for playing back the digital signal from the recording medium, the digital signal recording and playback apparatus comprising:
a recording control module which controls recording of the digital signal to the recording medium;
a playback control module which controls playback of the digital signal from the recording medium;
an encryption module which encrypts the digital signal;
a decryption module which decrypts the encrypted digital signal; and
a control module which controls the recording control module, the encryption module, the decryption module, and the playback control module; wherein:
a control flag relating to copy control or playback control is added to the inputted digital signal; and
the control module performs control so that digital signals are recorded to a first and second recording areas on the recording medium, the first recording area storing an ordinary digital signal, the second recording area storing the digital signal including the added control flag after the digital signal is encrypted, the control module further performing control so that an encryption key of the digital signal recorded to the second recording area is erased under a specified condition.

2. The digital signal recording and playback apparatus according to claim 1, wherein:
the control flag indicates that the inputted digital signal is Copy Never content.

3. The digital signal recording and playback apparatus according to claim 1, wherein:
the control module performs control so that playback of the digital signal recorded to the second recording area is permitted only for the purpose of time shift playback.

4. The digital signal recording and playback apparatus according to claim 3, wherein:
the control module performs control so that the inputted digital signal is recorded to the second recording area in rotation.

5. The digital signal recording and playback apparatus according to claim 1, wherein:
the first and second recording areas are partitions.

6. The digital signal recording and playback apparatus according to claim 1, wherein:
the specified condition is the time at the end of recording.

7. The digital signal recording and playback apparatus according to claim 1, wherein:
the specified condition is the time of the first access after the end of recording.

8. The digital signal recording and playback apparatus according to claim 1, wherein:
the specified condition is the time of turning off the power supplied to the digital signal recording and playback apparatus.

9. The digital signal recording and playback apparatus according to claim 1, further comprising a nonvolatile memory module which stores the encryption key, wherein:
the encryption key of the encrypted digital signal to be recorded to the recording medium is stored in the nonvolatile memory module.

10. The digital signal recording and playback apparatus according to claim 1, wherein:
the recording medium is a removable recording medium.

11. The digital signal recording and playback apparatus according to claim 1, wherein:
the recording medium includes an authentication module which performs authentication.

12. The digital signal recording and playback apparatus according to claim 11, wherein:
only when the authentication is successfully completed between the authentication module and the detection control module, the second recording medium becomes accessible.

13. A digital signal recording and playback apparatus for recording an inputted digital signal to a recording medium, and for playing back the digital signal from the recording medium, the digital signal recording and playback apparatus comprising:
a recording control module which controls recording of the digital signal to the recording medium;
a playback control module which controls playback of the digital signal from the recording medium;
an encryption module which encrypts the digital signal;
a decryption module which decrypts the encrypted digital signal; and
a control module which controls the recording control module, the encryption module, the decryption module, and the playback control module; wherein:
a playback control flag relating to playback restrictions is added to the inputted digital signal; and
the control module performs control so that digital signals are recorded to a first recording area and a second recording area on the recording medium, the first recording area storing an ordinary digital signal, the second recording area storing the digital signal including the added control flag after the digital signal is encrypted, the control module further performing control so that an encryption key of the digital signal recorded to the second recording area is erased under specified conditions.
